(19) United States
(12) Patent Application Publication
(10) Pub. No.: US 2025/0035948 A1
(43) Pub. Date: Jan. 30, 2025

(54) OPTICAL STACK INCLUDING REFLECTIVE POLARIZER AND OPTICAL LENS

(71) Applicant: 3M INNOVATIVE PROPERTIES COMPANY, St. Paul, MN (US)

(72) Inventors: John D. Le, San Jose, CA (US); Matthew C. Dachel, Baldwin, WI (US); Benjamin G. Sonnek, Mahtomedi, MN (US); Arthur L. Kotz, Woodbury, MN (US); David J.W. Aastuen, Shoreview, MN (US); Timonthy L. Wong, West. St. Paul, MN (US)

(21) Appl. No.: 18/716,630

(22) PCT Filed: Nov. 29, 2022
(86) PCT No.: PCT/IB2022/061554

§ 371 Date: Jun. 5, 2024

Related U.S. Application Data
(60) Provisional application No. 63/290,131, filed on Dec. 16, 2021.

(51) Int. Cl. G02B 27/28; G02B 1/04

(52) U.S. Cl. CPC G02B 27/286; G02B 1/041

(57) ABSTRACT

An optical stack includes a reflective polarizer disposed on, and substantially conforming to, a major surface of an optical lens. The reflective polarizer substantially reflects light having a first polarization state and substantially transmits light having an orthogonal second polarization state. The optical lens has an optical retardance of greater than 10 nm at a first location in a largest optically active region of the optical lens. A same principal axis of the optical retardance is aligned with a same one of the first and second polarization states to within about 10 degrees at the first location.

### SUMMARY

In some aspects, the present description provides an optical stack including a reflective polarizer disposed on, and substantially conforming to, a major surface of an optical lens. The reflective polarizer substantially reflects light having a first polarization state and substantially transmits light having an orthogonal second polarization state. The optical lens can have an optical retardance of greater than 10 nm at a first location in a largest optically active region of the optical lens. A same principal axis of the optical retardance is aligned with a same one of the first and second polarization states to within about 10 degrees at the first location.

In some aspects, the present description provides an optical stack including a reflective polarizer disposed on, and substantially conforming to, a major surface of an optical lens. The reflective polarizer substantially reflects light having a first polarization state and substantially transmits light having an orthogonal second polarization state. The optical lens has an optical retardance of greater than 10 nm at a first location in a largest optically active region of the optical lens. When the optical stack is disposed adjacent an absorbing polarizer with the optical lens disposed between the reflective and absorbing polarizers, where the absorbing polarizer substantially absorbs light having the second polarization state and substantially transmits light having the first polarization state, an optical transmittance through the optical stack and the absorbing polarizer of a substantially collimated light having the second polarization state and incident on the reflective polarizer is less than about 0.5%. The substantially collimated light fills at least a first region of the largest optically active region of the optical lens, where the first region comprises the first location and at least 50% of the largest optically active region of the optical lens.

These and other aspects will be apparent from the following detailed description. In no event, however, should this brief summary be construed to limit the claimable subject matter.

### BRIEF DESCRIPTION OF THE DRAWINGS

FIG. 1 is a schematic cross-sectional view of an optical stack including a reflective polarizer disposed on a major surface of an optical lens, according to some embodiments.

FIG. 2 is a schematic front view of an optical lens, according to some embodiments.

FIG. 3 is a schematic front view of a molded part that can be used to make a polymeric optical lens, according to some embodiments.

FIG. 4 is a schematic plot of the percent of an area of an optical lens having an orientation of a same principal axis of a retardance of the optical lens within a specified angular limit as a function of the angular limit for different areas, according to some embodiments.

FIG. 5 is a schematic plot of an average of a magnitude of an orientation angle of a same principal axis of a retardance in a region of an optical lens as a function of a ratio of the diameter of the region to a diameter of a largest optically active region of the optical lens, according to some embodiments.

FIG. 6 is a plot of an average of a magnitude of an orientation angle of a same principal axis of a retardance in a region of an optical lens as a function of radius from the center of the optical lens for different optical lenses, according to some embodiments.

FIG. 7 is a schematic illustration of light incident on an optical stack disposed adjacent to an absorbing polarizer, according to some embodiments.

FIG. 8 is a contour plot illustrating optical transmittance through an optical stack and an absorbing polarizer, according to some embodiments.

### DETAILED DESCRIPTION

In the following description, reference is made to the accompanying drawings that form a part hereof and in which various embodiments are shown by way of illustration. The drawings are not necessarily to scale. It is to be understood that other embodiments are contemplated and may be made without departing from the scope or spirit of the present description. The following detailed description, therefore, is not to be taken in a limiting sense.

It has typically been desired for optical lenses to have a low retardance since the retardance of the optical lens can have undesired effects on the performance of the optical lens in an optical system. However, according to some embodiments of the present description, it has been found that an optical lens having a relatively high retardance (e.g., an optical retardance of greater than 10 nm) can be useful in a variety of optical systems. For example, according to some embodiments, an optical stack that includes a reflective polarizer disposed on the optical lens with a pass or block axis of the reflective polarizer substantially aligned with a same principal axis (one of a fast axis and a slow axis) of the retardance in at least a region where the retardance is greater than 10 nm, for example, can be used in an optical system without the retardance significantly adversely affecting the performance of the optical system even when the retardance is large. The optical lens can be or include a polymeric lens that is insert molded onto the reflective polarizer. Molded polymeric optical lenses have traditionally been made from resins that result in a low retardance. Since the optical lenses of the present description can have a larger retardance, a wide variety of different (e.g., less expensive) resins may be used in forming the optical lens. In some embodiments, an optical lens comprises at least one of polycarbonate, polystyrene, polyester, amorphous polyolefin, or styrene methyl methacrylate.

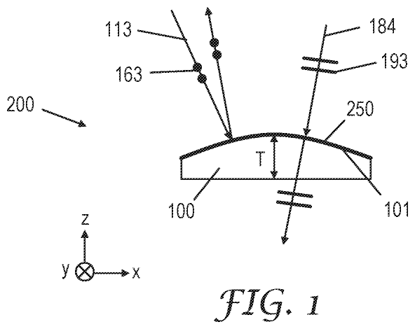

FIG. 1 is a schematic cross-sectional view of an optical stack 200 including a reflective polarizer 250 disposed on a major surface 101 of an optical lens 100, according to some embodiments. The optical lens 100 can have any suitable shape. The optical lens 100 may be biconvex, plano-convex, positive meniscus, negative meniscus, plano-concave, or biconcave, for example. In some embodiments, the reflective polarizer 250 is disposed on a convex major surface of the optical lens 100. The reflective polarizer may include a plurality of alternating polymeric layers. Such reflective polarizers are described in U.S. Pat. No. 5,882,774 (Jonza et al.); U.S. Pat. No. 6,783,349 (Neavin et al.); U.S. Pat. No. 6,949,212 (Merrill et al.); U.S. Pat. No. 6,967,778 (Wheatley et al.); and U.S. Pat. No. 9,162,406 (Neavin et al.). Suitable reflective polarizers include those available from 3M Company (St. Paul, MN) under the tradenames DBEF and APF. The optical stack 200 can be used in an optical system as described in U.S. Pat. No. 9,557,568 (Ouderkirk et al), for example.

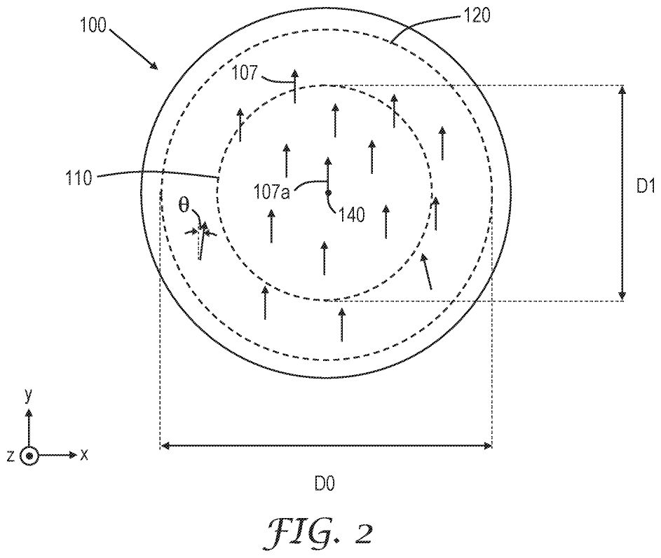

FIG. 2 is a schematic front view of an (e.g., polymeric) optical lens 100, according to some embodiments. The optical lens 100 has an optical retardance having a same principal axis 107 which can have an orientation within specified limits (e.g., within 5, 4, 3, 3.5, or 2 degrees of a same first direction) of a specified direction (e.g., y-direction) in at least a specified portion (e.g., at least 30, 35, 40, 45, 50, 55, 60, 65, 70, 75, 80, 85, or 90 percent by area) of a first region 110 of a largest optically active region 120 of the optical lens 100. The same principal axis can be one of a slow axis or a fast axis. The largest optically active region 120 of the optical lens 100 may be the entire optical lens 100 with the possible exception of an edge region of the optical lens 100, for example. In some embodiments, in a plan view (e.g., facing a curved major surface of the optical lens), the first region 110 is a circular region substantially centered on a first location 140 (e.g., a center of the first region can differ from the first location 140 by less than 20, 15, 10, or 5 percent of a diameter D1 of the first region). In some such embodiments, or in other embodiments, the first region 110 has a diameter D1 of at least 50, 55, 60, 65, 70, 75, or 80 percent of a diameter DO of the largest optically active region 120 of the optical lens 100. In some embodiments, the first region 110 comprises at least 60, 70, 80, 85, or 90 percent (e.g., by area of a first major surface of the optical lens) of a largest optically active region 120 of the optical lens 100. In some embodiments, the largest optically active region 120 comprises at least 60, 70, 80, 85, or 90 percent (e.g., by area of a first major surface of the optical lens) of the optical lens 100.

The optical retardance can be measured along a same direction (e.g., a direction substantially orthogonal to each of the opposing major surfaces of the optical lens proximate a center of the optical lens) and may be evaluated a wavelength (e.g., 432 nm, 550 nm, or 633 nm) in a visible wavelength range (e.g., about 400 nm to about 700 nm). The same principal axes of the retardance are then along directions orthogonal to the same direction which may be an optical axis (z-axis) of the optical lens 100. The retardance can be specified as a function of location on a major surface of the optical lens. In some embodiments, the optical retardance is greater than 10, 12, 14, 16, 18, or 20 nm in at least a portion of the largest optically active region 120. This optical retardance can be less than 200, 150, or 100 nm, for example. The portion can be in the first region 110 (e.g., at or near location 140) or can be near an outer boundary of the largest optically active region 120. In some embodiments, a maximum thickness (see, e.g., maximum thickness T schematically illustrated in FIG. 1) of the optical lens is less than 1, 0.8, 0.6, 0.5, or 0.4 cm. The maximum thickness can be greater than 0.05 or 0.1 cm, for example.

In some embodiments, an optical stack 200 includes a reflective polarizer 250 disposed on, and substantially conforming to, a major surface 101 of the optical lens 100. The reflective polarizer 250 substantially reflects (e.g., average reflectance greater than 50, 60, 70, 80, or 90 percent for (e.g., substantially normally incident) light in a wavelength range of about 420 nm to about 680 nm) light 113 having a first polarization state 163 and substantially transmits (e.g., average transmittance greater than 50, 60, 70, 80, or 90 percent for (e.g., substantially normally incident) light in a wavelength range of about 420 nm to about 680 nm) light 184 having an orthogonal second polarization state 193. The optical lens 100 can have an optical retardance of greater than 10, 12, 14, 16, 18, or 20 nm at a first location in a largest optically active region 120 of the optical lens 100. The first location can be a location near a center of the lens (e.g., location 140) or a location near the boundary of largest optically active region 120, for example. A same principal axis 107 of the optical retardance can be aligned with a same one of the first and second polarization states 163 and 193 to within about 10, 8, 6, 5, 4, 3 or 2 degrees at the first location. In some embodiments, a same principal axis 107 of the optical retardance can be aligned with the first polarization state 163 to within about 10 degrees for each location in at least 60%, 65%, 70%, 75%, 80%, 85%, or 90% (e.g., by area of the major surface 101) of the largest optically active region 120 of the optical lens 100. In some embodiments, the same principal axis 107 of the optical retardance is aligned with the first polarization state 163 to within about 8, 6, 5, 4, 3, or 2 for each location in at least the specified percentage (e.g., at least 60%) of the largest optically active region 120. The angle between the same principal axis 107 and the polarization state can be understood to be an angle measured in the xy-plane when the retardance is measured along the z-axis. In some embodiments, the same principal axis of the optical retardance is a slow axis and the same one of the first and second polarization states is the first polarization state. In some embodiments, the same principal axis of the optical retardance is a fast axis and the same one of the first and second polarization states is the first polarization state.

The same principal axis 107 of the optical retardance can be aligned with a polarization state by determining the orientation of the same principal axis 107 that results from a direction of resin flow in a mold used to make the optical lens 100 and insert molding the optical lens onto the reflective polarizer with the reflective polarizer disposed in the mold so that the resulting same principal axis 107 of the retardance of the optical lens is aligned with a polarization state (e.g., the first polarizations state 163 so that the same principal axis 107 is substantially along the y-axis or the second polarization state 193 so that the same principal axis 107 is substantially along the x-axis. For example, the polarization state can be along the y-axis and an angle between the polarization state and the same principal axis can be the angle θ illustrated in FIG. 2.

In some embodiments, the reflective polarizer 250 is substantially coextensive with the major surface 101 (e.g., coextensive with the major surface 101 except possibly for region(s) near an edge of the major surface 101). In some embodiments, the reflective polarizer 250 is coextensive with greater than 50, 60, 70, 80, or 90 percent of a total area of the major surface 101.

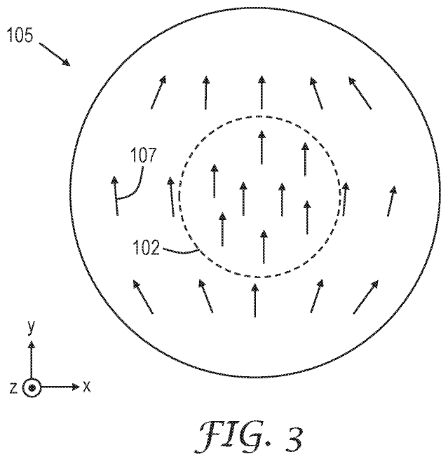

FIG. 3 is a schematic front view of a polymeric molded part 105 that may be used in making the optical lens 100, according to some embodiments. The molded part 105 has an optical retardance having a same principal axis 107 (e.g., slow or fast axis) that has a substantial variation in orientation. Such variation can result from the flow of resin in the molding process used to make the molded part 105. However, a portion 102 of the molded part 105 has a substantially uniform orientation of the same principal axis 107. For example, the portion 102 may be a region away from input or output gates of the mold where the resin flow in the mold is substantially uniform such that the substantially uniform flow results in a substantially uniform same principal axis orientation in the portion 102. Thus, removing the portion 102 (e.g., via cutting) from the molded part 105 can result in an optical lens 100 having a substantially uniform orientation of the same principal axis 107.

The optical stack 200 may be formed by insert molding the part 105 onto a reflective polarizer substantially coextensive with the portion 102 and then removing the portion 102 with the reflective polarizer from the resulting part. Alternatively, a reflective polarizer may be thermoformed into a desired shape and adhered to the surfaces of the optical lens 100 via an optically clear adhesive for example. Suitable insert molding and thermoforming processes are generally described in U.S. Pat. Appl. Pub. No. 2021/0208320 (Ambur et al.) and in U.S. Pat. No. 11,065,855 (Klun et al.), for example.

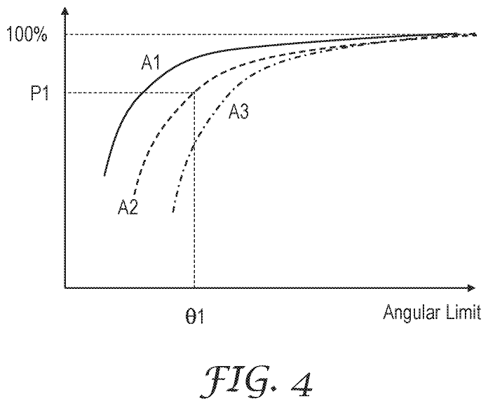

FIG. 4 is a schematic plot of a percent of an area having an orientation of a same principal axis of a retardance of an optical lens within a specified angular limit as a function of the angular limit for different areas (A1, A3, A3), according to some embodiments. The same principal axis 107 of the optical retardance can have an orientation within an angular limit of θ1 of a same first direction (e.g., a magnitude of an angle between the orientation and the y-direction can be less than θ1 degrees) for each location in at least an area percent P1 of the first region 110 (having area A2 in FIG. 4) of the optical lens 100. The following table provides results for percent of the area of region 110 that has an orientation within a specified angular range for various percentages of a largest area (e.g., largest active area of a lens) for a molded part 105 and for optical lenses 1 and 2 which correspond to a portion 102 of the molded part 105 where optical lens 1 has half of the area of the molded part 105 and optical lens 2 has a third of the area of the molded part 105. The percentages of the molded part were calculated based on a model of resin flow in a mold for a base 8 lens where the fluid velocity vector was taken to correspond to the orientation of the same principal axis retardance of the lens. Accuracy of the model was confirmed by molding a base 8 lens and measuring the same principal axis (slow axis in this case) orientation. The percentages of the optical lenses were calculated based on scaling from the molded part results.

| Region Area Percent | | | Percent of Region Area | | | |
|---|---|---|---|---|---|---|
| of Largest Area | | | Within Angular Range | | | |
| Molded | | | 0 to 2 | 0 to 3 | 0 to 4 | 0 to 5 |
| Part | Lens 1 | Lens 2 | degrees | degrees | degrees | degrees |
| 8.3% | 16.7% | 25.0% | 90.8% | 99.3% | 99.9% | 100.0% |
| 16.7% | 33.3% | 50.0% | 54.0% | 74.8% | 89.7% | 97.2% |
| 25.0% | 50.0% | 75.0% | 38.8% | 54.7% | 68.0% | 78.8% |
| 33.3% | 66.7% | 100.0% | 32.4% | 44.6% | 55.2% | 64.5% |
| 41.7% | 83.3% | | 30.0% | 39.6% | 48.4% | 56.7% |
| 50.0% | 100.0% | | 28.6% | 38.5% | 47.1% | 54.3% |
| 58.3% | | | 26.0% | 37.6% | 46.2% | 53.1% |
| 66.7% | | | 23.3% | 34.1% | 42.0% | 48.5% |
| 75.0% | | | 20.8% | 30.4% | 37.7% | 43.6% |
| 83.3% | | | 19.4% | 28.4% | 35.2% | 40.8% |
| 91.7% | | | 19.5% | 28.5% | 35.3% | 40.9% |
| 100% | | | 19.6% | 28.7% | 35.5% | 41.1% |

In some embodiments, the same principal axis 107 of the optical retardance has an orientation within 01 of a same first direction (e.g., y-direction) for each location in at least P1 of the first region 110 of the optical lens 100. In some embodiments, θ1 is about 5, 4, 3, or 2 degrees. In some such embodiments, or in other embodiments, P1 is at least 30, 35, 40, 45, 50, 55, 60, 65, 70, 75, 80, 85, or 90 percent. For example, in some embodiments, the same principal axis 107 of the optical retardance has an orientation within about 5 degrees of a same first direction for each location in at least 60% of the first region 110 of the optical lens 100, where the first region comprising at least 60% of a largest optically active region 120 of the optical lens 100. In some such embodiments, or in other embodiments, the same principal axis 107 of the optical retardance has an orientation within about 4 degrees of the same first direction for each location in at least 60% of the first region of the polymeric optical lens. In some such embodiments, or in other embodiments, the same principal axis 107 of the optical retardance has an orientation within about 3 degrees of the same first direction for each location in at least 50% of the first region of the polymeric optical lens. In some such embodiments, or in other embodiments, the same principal axis 107 of the optical retardance has an orientation within about 2 degrees of the same first direction for each location in at least 35% of the first region of the polymeric optical lens. As another example, in some embodiments, a same principal axis 107 of the optical retardance has an orientation within about 3 degrees of the same first direction for each location in at least 45% of the first region 110 of the optical lens 100, where the first region comprises at least 60% of the largest optically active region 120 of the optical lens 100. In some such embodiments, or in other embodiments, the same principal axis 107 of the optical retardance has an orientation within about 3 degrees of the same first direction for each location in at least 55% of the first region of the polymeric optical lens. In some such embodiments, or in other embodiments, the same principal axis of the optical retardance has an orientation within about 2 degrees of the same first direction for each location in at least 35% of the first region of the polymeric optical lens. As still another example, in some embodiments, a same principal axis 107 of the optical retardance has an orientation within about 2 degrees of the same first direction for each location in at least 30%, 35%, 40%, 45%, or 50% of the first region 110 of the optical lens 100, where the first region comprises at least 60% of the largest optically active region 120 of the optical lens 100. The first region can include a first location where the optical lens has an optical retardance of greater than 10, 12, 14, 16, 18, or 20 nm, for example.

In some embodiments, the same principal axis 107 of the optical retardance has an orientation within about 10, 8, 6, 5, 4, 3 or 2 degrees of the same one of the first and second polarization states for each location in at least 60% of a first region 110 of the optical lens, where the first region 110 comprises the first location (e.g., location 140) and at least 50% of the largest optically active region 120 of the optical lens 100. In some embodiments, the orientation is within the specified limits for each location in at least 60, 70, 80, 85, or 90 percent of the first region 110 of the optical lens 100. In some such embodiments, or in other embodiments, the first region 110 comprises at least 60, 70, 80, 85 or 90 percent of the largest optically active region 120 of the optical lens 100.

In some embodiments, the same principal axis 107 of the optical retardance has an orientation within about 5, 4, 3 or 2 degrees of the same one of the first and second polarization states for each location in at least 45% of a first region 110 of the optical lens, where the first region 110 comprises the first location (e.g., location 140) and at least 50% of the largest optically active region 120 of the optical lens 100. In some embodiments, the orientation is within the specified limits for each location in at least 50, 60, 70, 80, 85, or 90 percent of the first region 110 of the optical lens 100. In some such embodiments, or in other embodiments, the first region 110 comprises at least 60, 70, 80, 85 or 90 percent of the largest optically active region 120 of the optical lens 100.

In some embodiments, the same principal axis 107 of the optical retardance has an orientation within about 3 or 2 degrees of the same one of the first and second polarization states for each location in at least 30% of a first region 110 of the optical lens, where the first region 110 comprises the first location (e.g., location 140) and at least 50% of the largest optically active region 120 of the optical lens 100. In some embodiments, the orientation is within the specified limits for each location in at least 35, 40, 45, 50, 55, 60, 65, 70, 75, or 80 percent of the first region 110 of the optical lens 100. In some such embodiments, or in other embodiments, the first region 110 comprises at least 60, 70, 80, 85 or 90 percent of the largest optically active region 120 of the optical lens 100.

The orientation of the same principal axis of the retardance of the optical lens can be described in terms of 01, P1, as described elsewhere herein. Alternatively, or additionally, the orientation of the same principal axis of the retardance may be described in terms of an average of a magnitude of an orientation angle of a same principal axis of a retardance in a region of the optical lens.

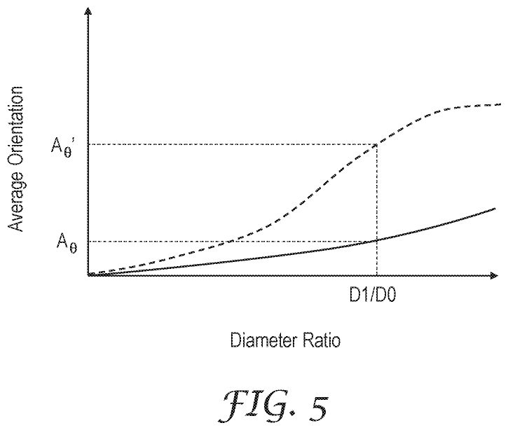

FIG. 5 is a schematic plot of an average of a magnitude of an orientation angle of a same principal axis 107 of a retardance in a region 110 as a function of a ratio of the diameter D1 of the region 110 to a diameter DO of a largest optically active region 120 of an optical lens 100, according to some embodiments. The orientation angle at a given location can be an angle between the same principal axis at the given location and the same principal axis at a fixed first location. An average A_{θ} for an optical lens 100 and an average A_{θ}′ for a comparative lens (e.g., corresponding to molded part 105) is illustrated. Results for a molded base 8 lens shows that A_{θ}′ is about 6 degrees for D0/D1 of about 0.5.

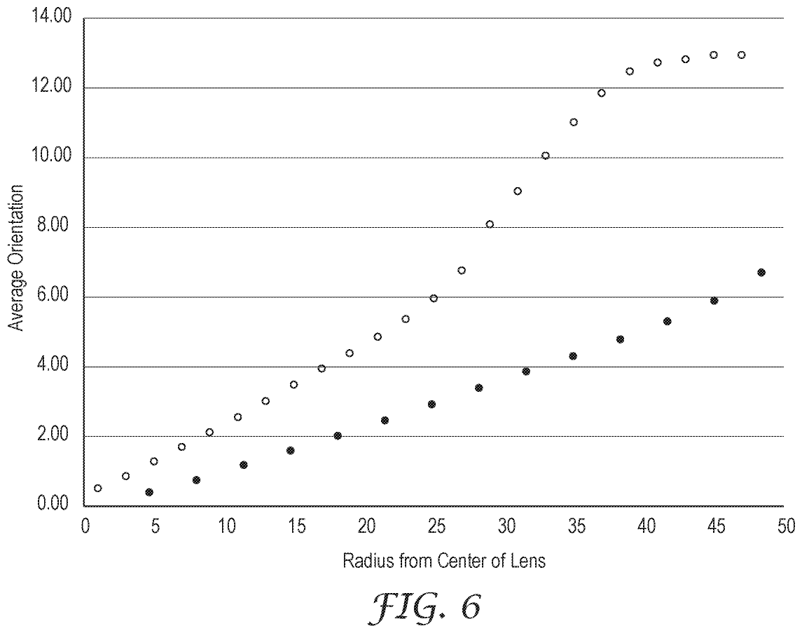

FIG. 6 is a plot of an average of a magnitude of an orientation angle of a same principal axis of a retardance in a region as a function of a radius of the region from the center of an optical lens, according to some embodiments. Data are shown as open circles for a molded part, which was a base 8 lens as described elsewhere herein. Results determined from this data for a lens cut from a larger lens (e.g., corresponding to molded part 105) are shown as solid circles.

In some embodiments, a same principal axis 107 of the optical retardance has a first orientation 107a at a first location 140 of the optical lens 100, where an average (A_{θ}) in a first region 110 of the optical lens 100 of a magnitude of an angle of the same principal axis relative to the first orientation is less than κ, 4.5, 4, 3.5, 3.25 or 3 degrees, where in a plan view, the first region 110 is a circular region substantially centered on the first location 140 and having a diameter D1 of at least 50% of a diameter DO of the largest optically active region 120 of the optical lens 100. In some embodiments, D1 is at least 55, 60, 65, 70, 75, or 80 percent of DO. In some embodiments, the plan view is along a direction substantially orthogonal to each of the opposing major surfaces of the optical lens proximate a center of the optical lens (e.g., an optical axis of the optical lens 100.

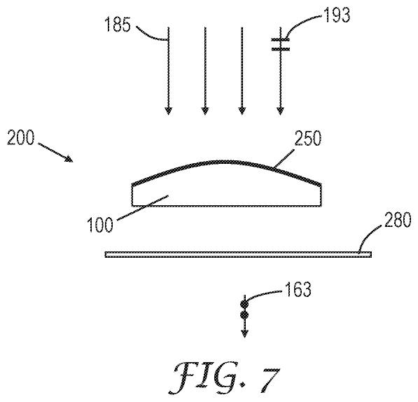

FIG. 7 is a schematic illustration of a substantially collimated light 185 incident on an optical stack 200 disposed adjacent to an absorbing polarizer 280, according to some embodiments. The substantially collimated light 185 can have a divergence/convergence angle having a magnitude less than 20, 10, or 5 degrees, for example. The substantially collimated light 185 can fill at least a first region 110 of the largest optically active region 120 of the optical lens 100. The optical lens 100 can have an optical retardance of greater than 10 nm (or in a range described elsewhere herein) at a first location in a largest optically active region 120 of the optical lens 100. The optical lens 100 can be or include a monolithic lens substrate that has an optical retardance of greater than 10 nm (or in a range described elsewhere herein) at the first location. In some embodiments, the optical lens includes a plurality of monolithic lens substrates where at least one lens substrate has an optical retardance of greater than 10 nm (or in a range described elsewhere herein) at the first location. The first region 110 can comprise the first location and at least 50, 60, 70, 80, 85, or 90 percent of the largest optically active region 120 of the optical lens 100. In some embodiments, an optical stack 200 includes a reflective polarizer 250 disposed on, and substantially conforming to, a major surface of an optical lens 100, where the reflective polarizer substantially reflects light having a first polarization state 163 and substantially transmits light having an orthogonal second polarization state 193. The absorbing polarizer 280 can substantially absorb light having the second polarization state 193 and substantially transmit light having the first polarization state 163. In some embodiments, the absorbing polarizer 280 absorbs at least 99.9%, 99.99%, or 99.995% of light having the second polarization state 193. In some embodiments, when the optical stack 200 is disposed adjacent an absorbing polarizer 280 with the optical lens 100 disposed between the reflective and absorbing polarizers 250 and 280, an optical transmittance through the optical stack 200 and the absorbing polarizer 280 of a substantially collimated light having the second polarization state and incident on the reflective polarizer is less than about 0.5, 0.4, 0.3, 0.2, 0.1, 0.08, 0.06, 0.04, or 0.02 percent. The light 185 can be first incident on the reflective polarizer 250 as schematically illustrated in FIG. 9 or can be first incident on the absorbing polarizer 280. For the absorbing polarizer to be considered to substantially absorb light having the second polarization state 193, a transmittance of light having the second polarization state 193 through the absorbing polarizer should be small compared to the specified transmittance through the optical stack 200 and absorbing polarizer 280 of light 185. In some embodiments, the absorbing polarizer 280 absorbs at least 99.9%, 99.99%, 99.995%, or 99.999% of light having the second polarization state 193. In some embodiments, the absorbing polarizer 280 has an extinction coefficient (ratio of transmittance in pass state to transmittance in block state) of at least about 1000, 104, 105, or 10⁶. The light 185 can have at least one wavelength in a range of about 420 nm to about 680 nm. The light 185 may have a wavelength of 550 nm, for example. Various optical properties, such the extinction coefficient of the absorbing polarizer 280, can be specified as an average over wavelengths in the range of about 420 nm to about 680 nm or can be specified for a wavelength in this range (e.g., 550 nm).

The substantially collimated light 185 can be incident on the optical stack 200 along a first direction substantially orthogonal to each of the opposing major surfaces of the optical lens proximate a center of the optical lens (e.g., along an optical axis of the optical lens 100). The absorbing polarizer 280 can be disposed so that the first direction is orthogonal to the absorbing polarizer 280 and so that the light transmitted through the optical stack is incident on the absorbing polarizer 280.

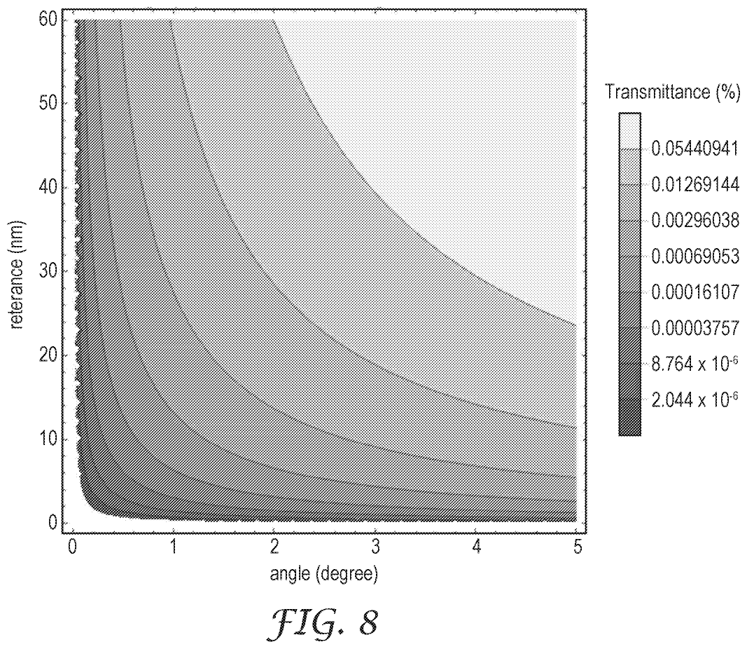

If the optical lens 100 had a zero retardance or a retardance with a fast or slow axis aligned with the second polarization state 193, the absorbing polarizer 280 would absorb light transmitted through the lens 100 so that substantially no light is transmitted through the absorbing polarizer 280. In contrast, a polymeric lens having a birefringence of 20 nm with a same principal axis oriented at a 45 degrees to the first and second polarization states 163 and 193, for example, would result in a transmittance through the absorbing polarizer 280 of about 1.3% of the incident light. FIG. 8 is a contour plot showing the percent of light 185 transmitted through absorbing polarizer 280 as a function of the retardance of the optical lens 100 and an orientation angle between the same principal axis 107 and the first polarization state 163 (e.g., along the y-axis), according to some embodiments. The plot shows that a low leakage can be obtained even when the retardance is high (e.g., greater than 10 nm) when the orientation of the same principal axis 107 is suitably controlled.

Terms such as “about” will be understood in the context in which they are used and described in the present description by one of ordinary skill in the art. If the use of “about” as applied to quantities expressing feature sizes, amounts, and physical properties is not otherwise clear to one of ordinary skill in the art in the context in which it is used and described in the present description, “about” will be understood to mean within 10 percent of the specified value. A quantity given as about a specified value can be precisely the specified value. For example, if it is not otherwise clear to one of ordinary skill in the art in the context in which it is used and described in the present description, a quantity having a value of about 1, means that the quantity has a value between 0.9 and 1.1, and that the value could be 1.

Terms such as “substantially” will be understood in the context in which they are used and described in the present description by one of ordinary skill in the art. If the use of “substantially” with reference to a property or characteristic is not otherwise clear to one of ordinary skill in the art in the context in which it is used and described in the present description and when it would be clear to one of ordinary skill in the art what is meant by an opposite of that property or characteristic, the term “substantially” will be understood to mean that the property or characteristic is exhibited to a greater extent than the opposite of that property or characteristic is exhibited.

All references, patents, and patent applications referenced in the foregoing are hereby incorporated herein by reference in their entirety in a consistent manner. In the event of inconsistencies or contradictions between portions of the incorporated references and this application, the information in the preceding description shall control.

Descriptions for elements in figures should be understood to apply equally to corresponding elements in other figures, unless indicated otherwise. Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations, or variations, or combinations of the specific embodiments discussed herein. Therefore, it is intended that this disclosure be limited only by the claims and the equivalents thereof.

1-15. (canceled)

16. An optical stack comprising:
an optical lens having an optical retardance of greater than 10 nm at a first location in a largest optically active region of the optical lens; and
a reflective polarizer disposed on, and substantially conforming to, a major surface of the optical lens, the reflective polarizer substantially reflecting light having a first polarization state and substantially transmitting light having an orthogonal second polarization state, a same principal axis of the optical retardance being aligned with a same one of the first and second polarization states to within about 6 degrees at the first location,
wherein the same principal axis of the optical retardance has an orientation within about 6 degrees of the same one of the first and second polarization states for each location in at least 60% of a first region of the optical lens, the first region comprising the first location and at least 60% of the largest optically active region of the optical lens.

17. The optical stack of claim 16, wherein the optical lens comprises a polymeric lens insert molded onto the reflective polarizer.

18. The optical stack of claim 16, wherein a maximum thickness of the optical lens is less than 1 cm.

19. The optical stack of claim 16, wherein a maximum thickness of the optical lens is less than 0.6 cm and the optical retardance of the optical lens at the first location is greater than 14 nm.

20. The optical stack of claim 16, wherein a maximum thickness of the optical lens is less than 0.4 cm and the optical retardance of the optical lens at the first location is greater than 20 nm.

21. The optical stack of claim 16, wherein the same principal axis of the optical retardance is a slow axis and the same one of the first and second polarization states is the first polarization state.

22. The optical stack of claim 16, wherein the same principal axis of the optical retardance is a fast axis and the same one of the first and second polarization states is the first polarization state.

23. The optical stack of claim 16, wherein the same principal axis of the optical retardance has an orientation within about 3 degrees of the same one of the first and second polarization states for each location in at least 30% of the first region of the optical lens.

24. The optical stack of claim 16, wherein the same principal axis of the optical retardance has an orientation within about 3 degrees of the same one of the first and second polarization states for each location in at least 60% of the first region of the optical lens.

25. The optical stack of claim 16, wherein when the optical stack is disposed adjacent an absorbing polarizer with the optical lens disposed between the reflective and absorbing polarizers, the absorbing polarizer substantially absorbing light having the second polarization state and substantially transmitting light having the first polarization state, an optical transmittance through the optical stack and the absorbing polarizer of a substantially collimated light having the second polarization state and incident on the reflective polarizer is less than about 0.5%, the substantially collimated light filling at least the first region of the largest optically active region of the optical lens.

26. The optical stack of claim 16, wherein the optical lens comprises at least one of polycarbonate, polystyrene, polyester, amorphous polyolefin, or styrene methyl methacrylate.

27. The optical stack of claim 16, wherein the optical lens comprises polyester.

28. The optical stack of claim 16, wherein the optical lens comprises amorphous polyolefin.

29. The optical stack of claim 16, wherein the optical lens comprises styrene methyl methacrylate.
